(19) United States
(12) Patent Application Publication
(10) Pub. No.: US 2023/0177462 A1
(43) Pub. Date: Jun. 8, 2023

(54) SYSTEMS AND METHODS FOR A SESSION-BASED COLLABORATION PLATFORM

(71) Applicant: Acentium Inc, Boston, MA (US)

(72) Inventor: Amine Hamdi, Boston, MA (US)

(73) Assignee: Acentium Inc, Boston, MA (US)

(21) Appl. No.: 18/074,970

(22) Filed: Dec. 5, 2022

Related U.S. Application Data
(60) Provisional application No. 63/286,446, filed on Dec. 6, 2021.

(51) Int. Cl. G06Q 10/10; G06F 16/93

(52) U.S. Cl. CPC G06Q 10/10; G06F 16/93

(57) ABSTRACT

Systems and methods for session-based collaboration can include a collaboration system detecting initiation of a session by a first user to share content of a workspace with a second user. The collaboration system can identify, based at least on the initiation of the session, settings defining the workspace, and generate a database of the specific to the second user using the settings and one or more access control permissions of the second user. The database can include copies of data items of the workspace to which the second user has permission to access. The collaboration system can provide the second user access to the database during the session. The collaboration system may delete the database upon detecting ending of the session.

### CROSS-REFERENCE TO RELATED APPLICATIONS

This application claims priority to, and the benefit of, U.S. Provisional Application No. 63/286446 filed on Dec. 6, 2021, and entitled “SYSTEMS AND METHODS FOR A SESSION-BASED COLLABORATION PLATFORM,” the content of which is incorporated herein by reference in its entirety.

### FIELD OF THE DISCLOSURE

The present application relates generally to systems and methods for a session-based collaboration platform. Specifically, the present application relates to systems and methods for sharing workspace data and related user interfaces.

### SUMMARY OF THE DISCLOSURE

According to at least one aspect, a system can include one or more processors and a memory storing computer executable instructions. The computer executable instructions, when executed by the one or more processors, can cause the one or more processors to detect initiation of a session by a first user to share content of a workspace with a second user, and identify, based at least on the initiation of the session, settings defining the workspace. The one or more processors can generate a database of the workspace specific to the second user using the settings and one or more access control permissions of the second user. The database can include copies of data items of the workspace to which the second user has permission to access. The one or more processors can provide the second user access to the database during the session.

In some implementations, the one or more processors can delete the database upon detecting ending of the session. In some implementations, the initiation of the session can include a computing device of the second user receiving a link of the workspace from a computing device of the first user, and the computing device of the second user activating the link. In detecting the initiation of the session, the one or more processors can detect activation of the link by the computing device of the second user. The link can include at least one of a workspace identifier or a session identifier.

In some implementations, the settings defining the workspace can include one or more user interface (UI) setting parameters, and the one or more processors can cause display of a first UI on a computing device of the second user using the one or more UI setting parameters and the session database specific to the second user. The first UI can display data associated with the session database specific to the second user. The first UI can correspond to a second UI displayed on a computing device of the first user, and the one or more processors can generate the one or more UI setting parameters to define at least one of a layout of the second UI or data associated with the workspace that is displayed by the second UI. Data displayed by the first UI can be similar to data displayed by the second UI except that the data displayed by the first UI can be limited to data associated with the workspace that is accessible by the second user and data displayed by the second UI can be limited to data associated with the workspace that is accessible by the first user. The one or more processors can detect a modification to the second UI displayed on the computing device of the first user, and update the one or more UI setting parameters responsive to detecting the modification to the second UI. The computing device of the second user can update the first UI displayed thereon responsive to updating the one or more UI setting parameters. The one or more processors can further cause display of a third UI on the computing device of the second user. The third UI can depict data common to both the first UI and the second UI.

In some implementations, the settings defining the workspace can include a query indicative of a scope of data associated with the workspace. In generating the database specific to the second user, the one or more processors can identify a plurality of data items associated with the workspace using the query, filter the plurality of data items using the one or more data access permissions of the second user to identify a filtered set of data items associated with the workspace and accessible by the second user, and generate the session database to include copies of the filtered set of data items. In some implementations, in providing access to the database, the one or more processors can provide a separate secure channel for each database specific to the second user.

According to at least one aspect, a method can include one or more processors detecting initiation of a session by a first user to share content of a workspace with a second user, and identifying, based at least on the initiation of the session, settings defining the workspace. The method can include the one or more processors generating a database of the workspace specific to the second user using the settings and one or more access control permissions of the second user. The database can include copies of data items of the workspace to which the second user has permission to access. The method can include the one or more processors providing the second user access to the database during the session.

In some implementations, the method can include the one or more processors deleting the database upon detecting ending of the session. In some implementations, the initiation of the session can include a computing device of the second user receiving a link from a computing device of the first user, and the computing device of the second user activating the link. Detecting the initiation of the session can include detecting activation of the link by the computing device of the second user. In some implementations, the link can include at least one of a workspace identifier or a session identifier.

In some implementations, the settings defining the workspace can include one or more user interface (UI) setting parameters, and the method can further include the one or more processors causing display of a first UI on a computing device of the second user using the one or more UI setting parameters and the session database specific to the second user. The first UI can display data associated with the database specific to the second user. The first UI can correspond to a second UI displayed on a computing device of the first user, and the method can further include the one or more processors generating the one or more UI setting parameters to define at least one of a layout of the second UI or data associated with the workspace that is displayed by the second UI. Data displayed by the first UI can be similar to data displayed by the second UI except that the data displayed by the first UI can be limited to data associated with the workspace that is accessible by the second user, and data displayed by the second UI can be limited to data associated with the workspace that is accessible by the first user. The method can further include the one or more processors detecting a modification to the second UI displayed on the computing device of the first user, and updating the one or more UI setting parameters responsive to detecting the modification to the second UI. The computing device of the second user can update the first UI displayed thereon responsive to updating the one or more UI setting parameters. The method can further include the one or more processors causing display of a third UI on the computing device of the second user. The third UI can depict data common to both the first UI and the second UI.

In some implementations, the settings defining the workspace can include a query indicative of a scope of data associated with the workspace. Generating the database specific to the second user can include the one or more processors identifying a plurality of data items associated with the workspace using the query, filtering the plurality of data items using the one or more data access permissions of the second user to identify a filtered set of data items associated with the workspace and accessible by the second user, and generating the session database to include copies of the filtered set of data items. In some implementations, providing access to the database can include the one or more processors providing a separate secure channel for each database specific to the second user.

According to at least one aspect, a computer-readable medium can include computer code instructions stored thereon. The computer code instructions when executed by one or more processors cause the one or more processors to detect initiation of a session by a first user to share content of a workspace with a second user, and identify, based at least on the initiation of the session, settings defining the workspace. The one or more processors can generate a database of the workspace specific to the second user using the settings and one or more access control permissions of the second user. The database can include copies of data items of the workspace to which the second user has permission to access. The one or more processors can provide the second user access to the database during the session.

In some implementations, the one or more processors may delete the database upon detecting ending of the session.

### BRIEF DESCRIPTION OF THE DRAWINGS

FIG. 1A is a block diagram depicting an embodiment of a network environment comprising local devices in communication with remote devices.

FIGS. 1B-1D are block diagrams depicting embodiments of computers useful in connection with the methods and systems described herein.

FIG. 2 shows a block diagram illustrating a network environment employing data access management, according to example embodiments.

FIG. 3 shows a flowchart illustrating a data access management method, according to example embodiments.

FIG. 4 shows an example UI for receiving input data regarding a workspace, according to example embodiments.

FIG. 5 shows a diagram illustrating a scenario where a user computing device is accessing a plurality of workspaces, according to example embodiments.

FIG. 6 shows a block diagram illustrating a collaboration system, according to example embodiments.

FIG. 7 shows a flowchart illustrating a session-based collaboration method, according to example embodiments.

FIG. 8 shows a signaling flowchart illustrating communications associated with a collaboration session between computing devices of two users the collaboration system, according to example embodiments.

FIGS. 9A-9D show diagrams illustrating various scenarios of data displayed to two users in a collaboration session, according to example embodiments.

### DETAILED DESCRIPTION

For purposes of reading the description of the various embodiments below, the following descriptions of the sections of the specification and their respective contents may be helpful:

Section A describes a computing and network environment, which may be useful for practicing embodiments described herein.

Section B describes systems and methods for session-based access management.

Section C describes systems and methods for a session-based collaboration platform.

### A. Computing and Network Environment

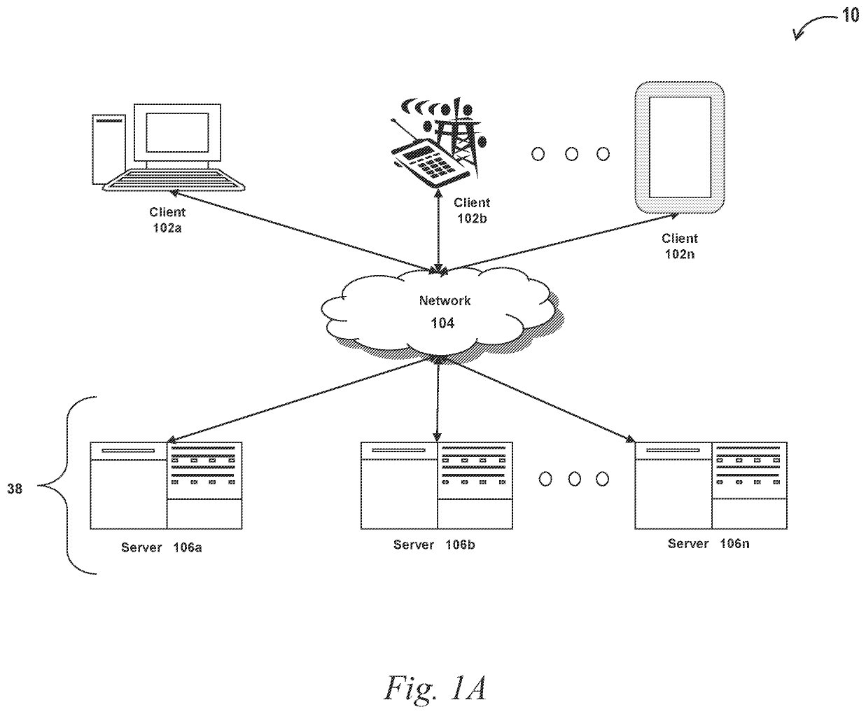

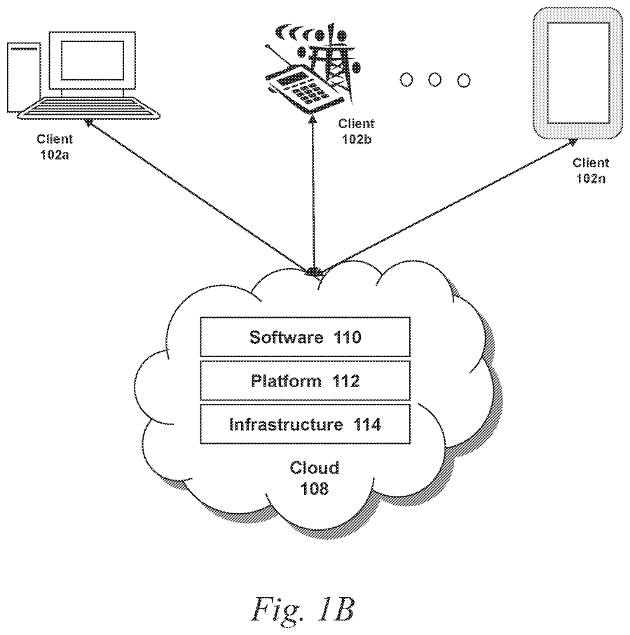

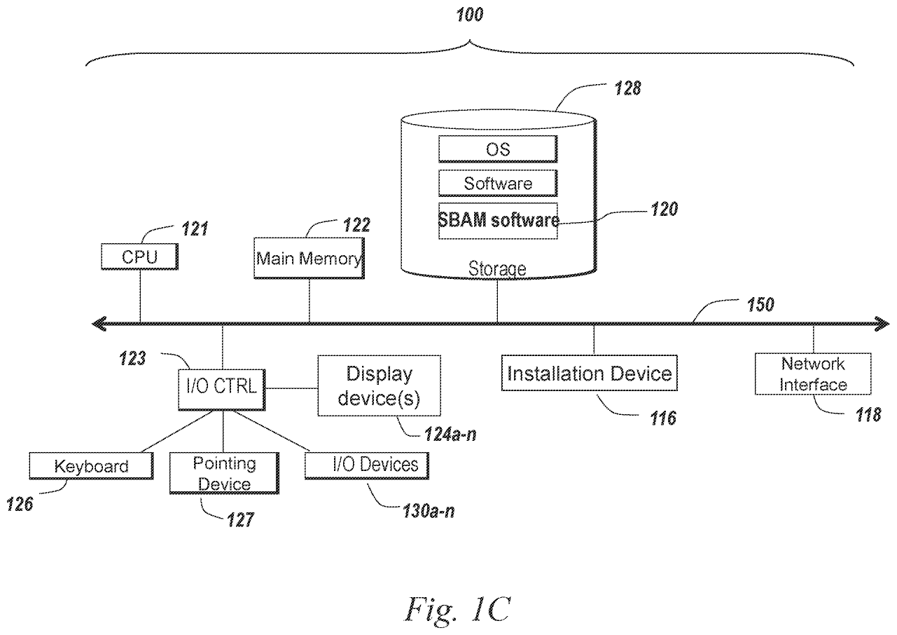

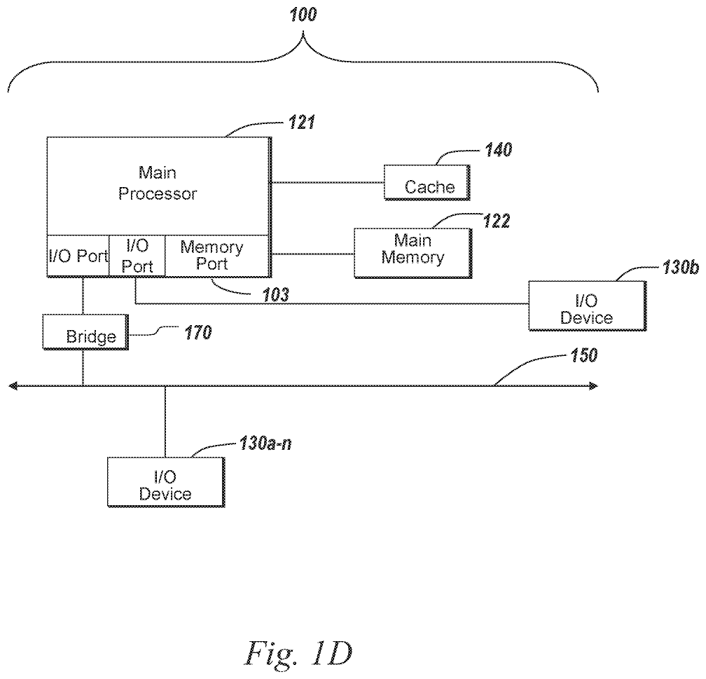

In addition to discussing specific embodiments of the present solution, it may be helpful to describe aspects of the operating environment as well as associated system components (e.g., hardware elements) in connection with the methods and systems described herein. Referring to FIG. 1A, an embodiment of a computing and network environment 10 is depicted. In brief overview, the computing and network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 1G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the computing and network environment 10 may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS 8 or 10, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, firewall, Internet of Things (IoT) controller. In one embodiment, the server 106 may be referred to as a remote machine or a node. In another embodiment, a plurality of nodes 290 may be in the path between any two communicating servers.

Referring to FIG. 1B, a cloud computing environment is depicted. The cloud computing environment can be part of the computing and network environment 10. A cloud computing environment may provide client 102 with one or more resources provided by the computing and network environment 10. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, for example, Salesforce Sales Cloud, or Google Drive app. Clients 102 may also access SaaS resources through the client operating system, including, e.g., Windows file system for DROPB OX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, session-based collaboration (SBC) software 120, and/or other software, among others. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, California; those manufactured by Motorola Corporation of Schaumburg, Illinois; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WIT, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the SBC software 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Washington; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Washington.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is a eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc.; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, central processing unit (CPU) and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Session-Based Access Management

The present disclosure relates to systems and methods for session-based access management of data. In computer environments, such as enterprise networks, cloud systems, banking systems, electric utility systems or medical device networks, among others, security of the data is very important to guarantee proper operation of the computer environment. Specifically, a breach of the security of the data can result in putting the whole computer environment or a portion thereof out of operation. The systems and methods described herein include providing users access to data through user-specific workspaces and limiting the access to the data at any point in time to no more than a predefined number of workspaces. Furthermore, systems and methods described herein provide access to temporary copies of data associated with a workspace rather than the original data.

A computer hacker can get access to a computer environment by breaking into a computing device of user that is accessing or connect to the computer environment. Once breaking into the computing device, the hacker can encrypt, destroy or steal all the data of the computer environment that is accessible to the user. The data accessible to the user includes all the data the user has permission to access. For many users, the amount of data for which they have permission to access can be huge. In addition, some users may have access to data of high value to stakeholders of the computer environment.

To ovoid scenarios where data of a computer environment is jeopardized due to the hacking of a user computing devices, a data access management system can limit the amount of data a user can access at any given time instance. Specifically, a user can create workspaces and access data through the workspaces. The data access management system he can restrict or limit the number of workspaces that can be simultaneously accessed by the user. Furthermore, the workspaces may not include data. Instead, each time the user opens or initiates a session with a workspace, the data access management system can create a temporary database including copies of data items associated with that workspace through which the user can access data of the workspace. Upon the user closing (or ending the session with) the workspace, the data access management system can delete the temporary database.

The embodiments described herein enhance data security in various ways. First, restricting the number of workspaces that can be simultaneously accessed by a given user limits the amount of data a hacker would get access to if they were to break through the computing device of the user. If the hacker were to attempt to access additional data beyond the maximum number of workspaces that can be accessed simultaneously, the data access management system will detect or interpret such attempt as a suspicious action and may completely block the hacked computing device from accessing any data. Second, the use of temporary databases that store copies of data items provides access to copies of the data items but not the original data items. As such, even if a hacker succeeds to break through a user computing device, they wouldn't be able to encrypt or destroy the original data.

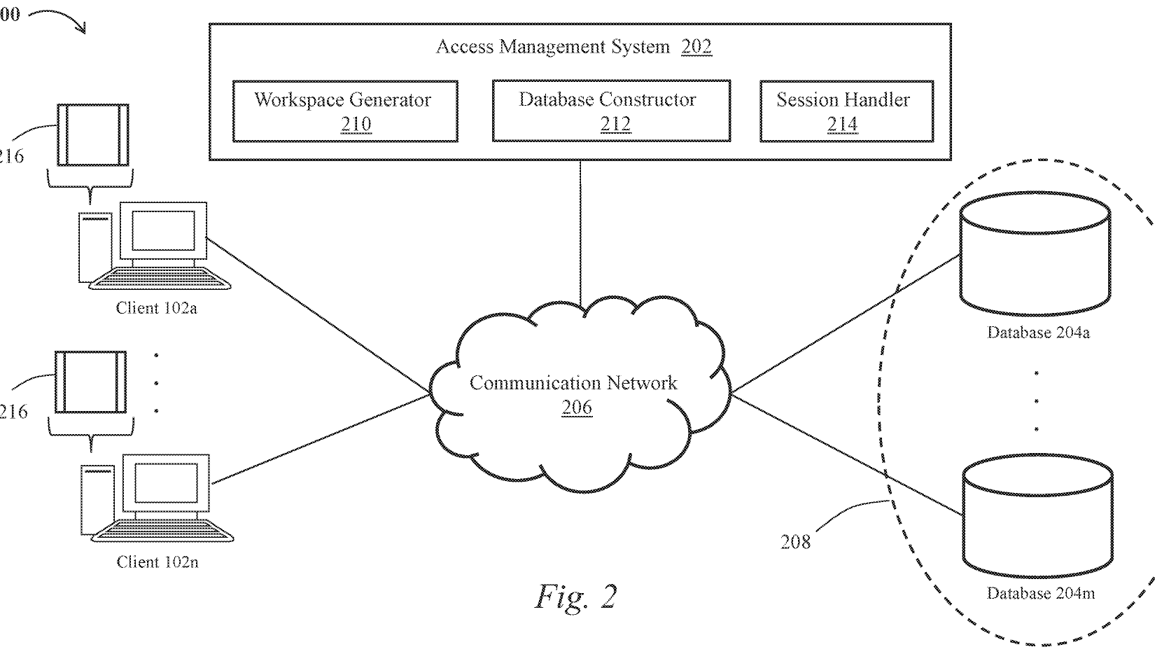

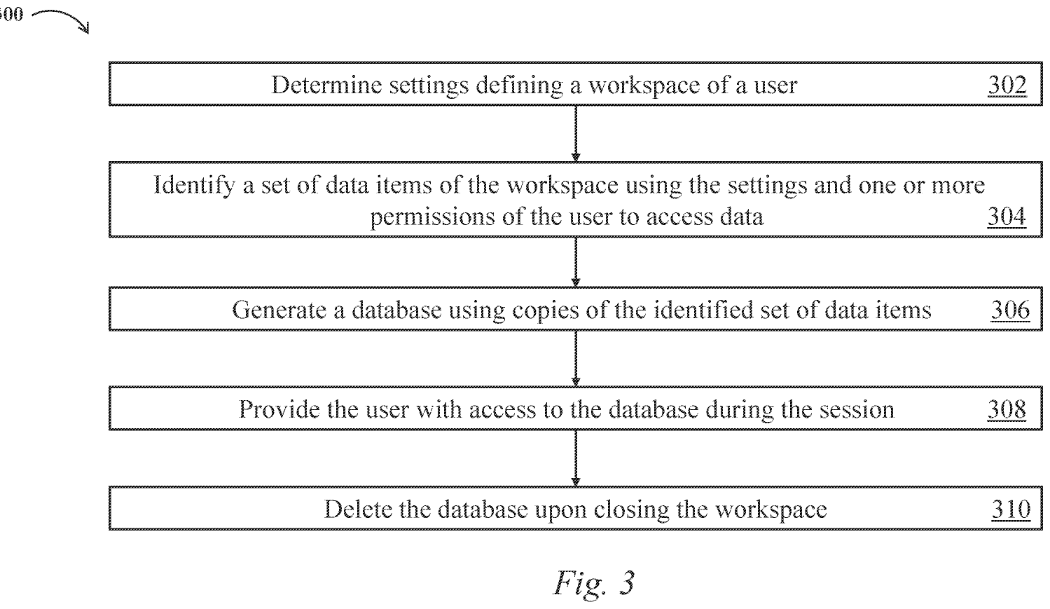

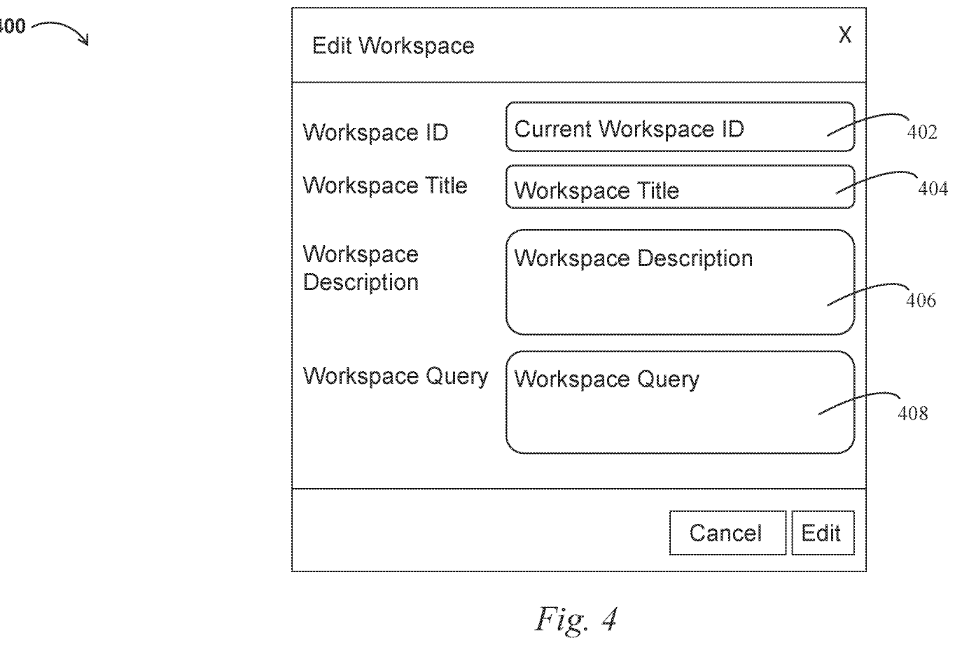

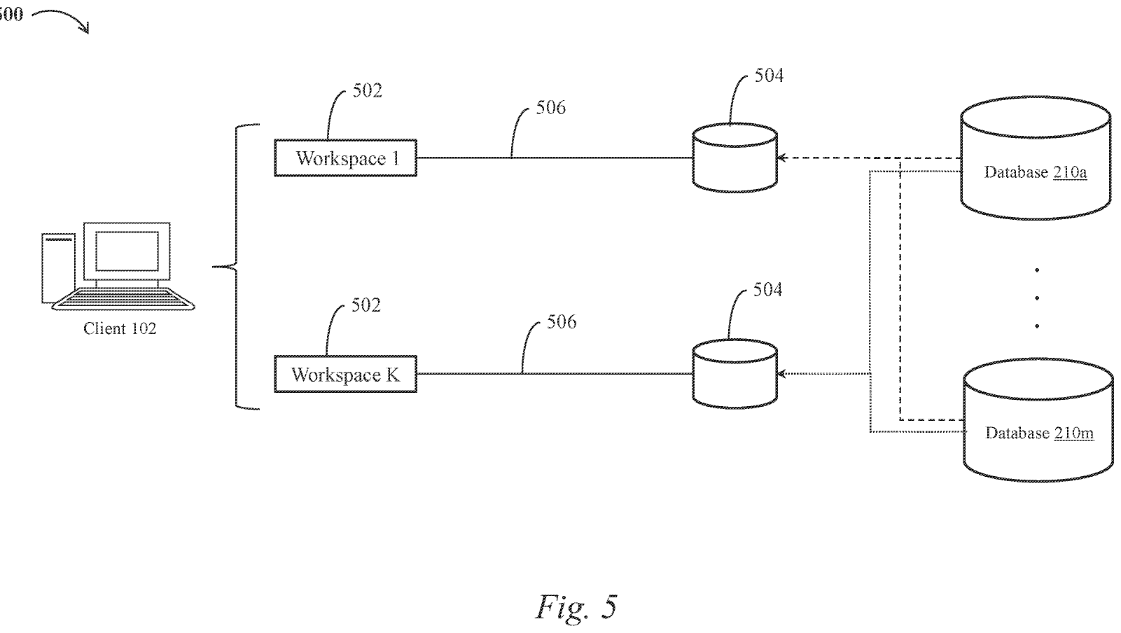

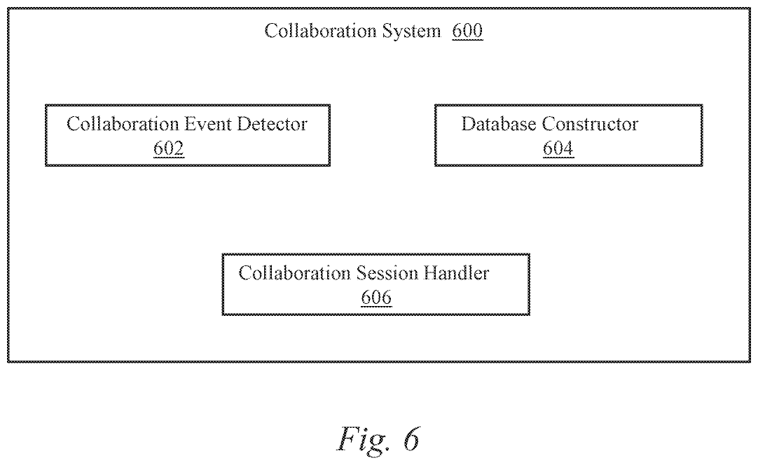

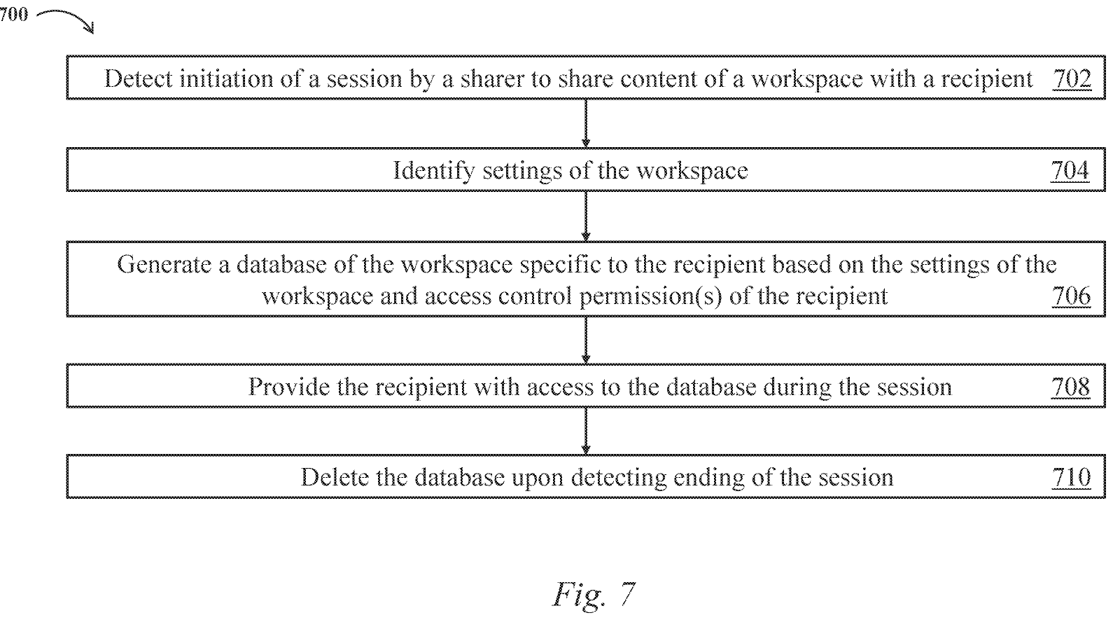

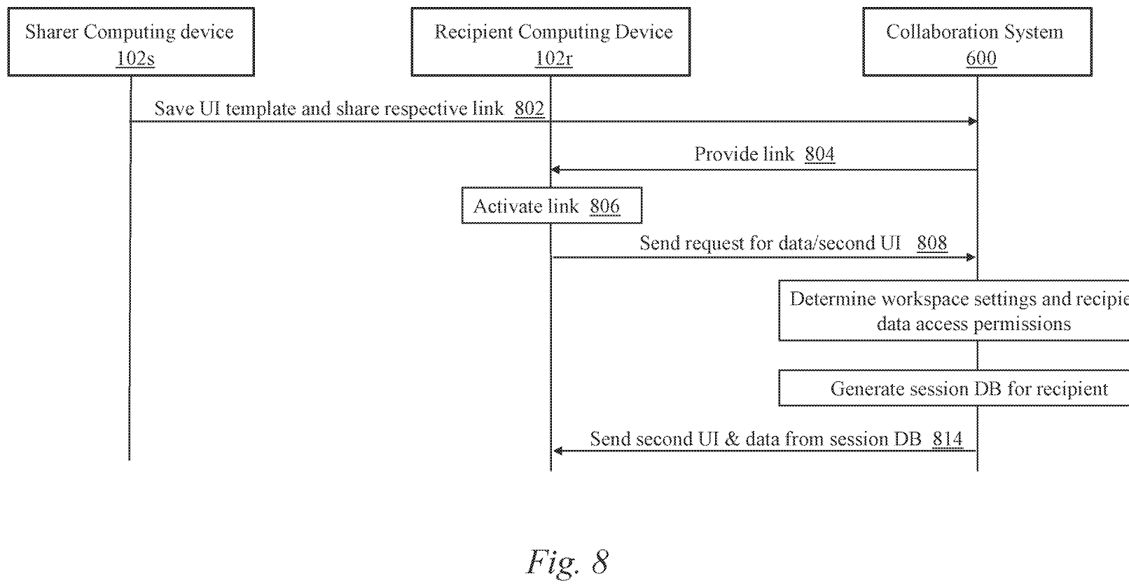

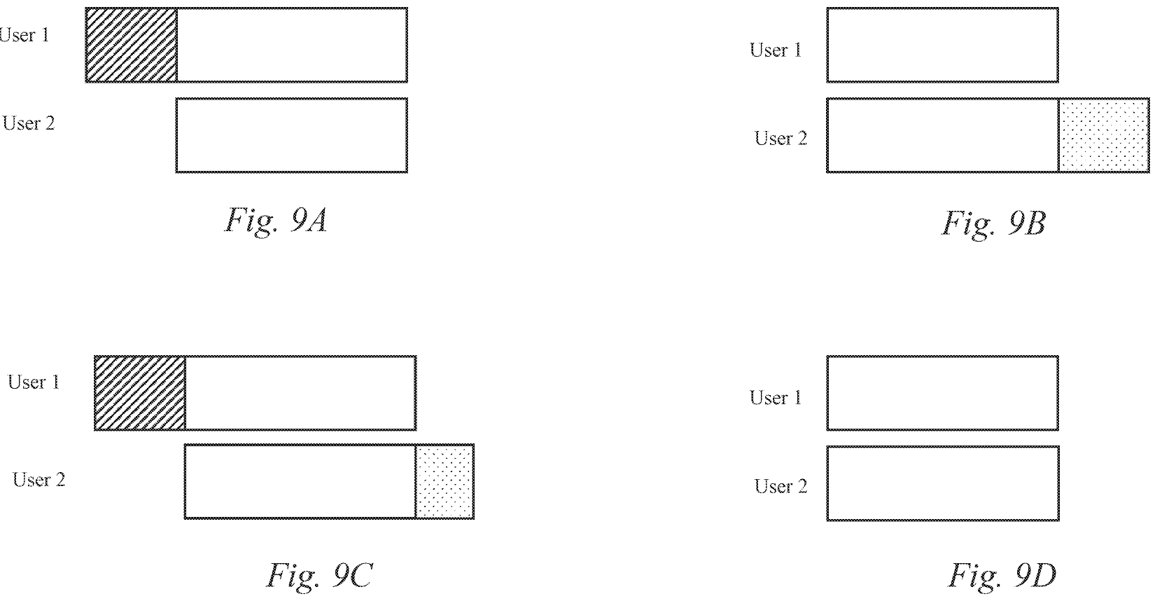

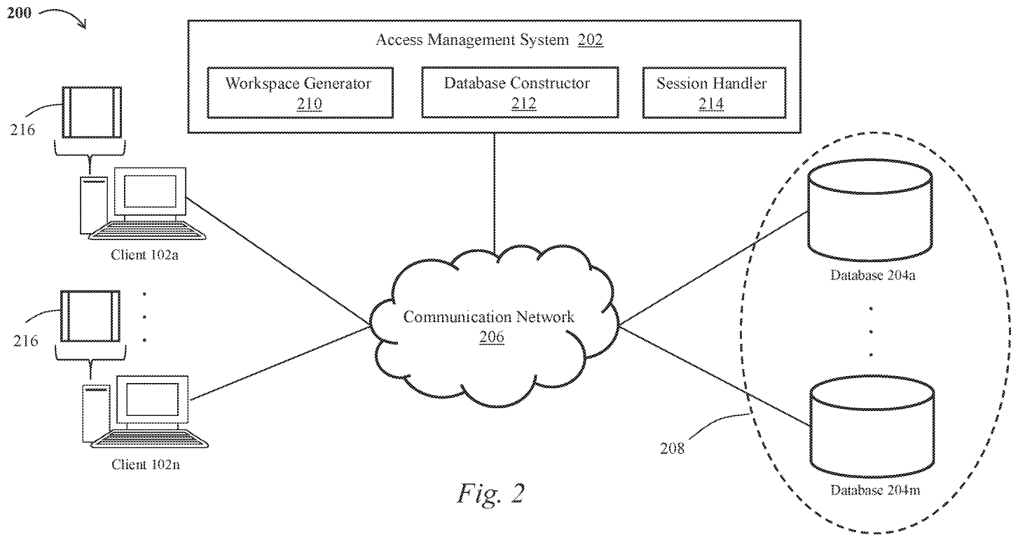

Referring now to FIG. 2, a block diagram illustrating a network environment 200 employing data access management is shown, according to example embodiments. The computer network 200 can include a plurality of client computing devices 102a-102n, an access management system 202, a plurality of databases 204a-204m and a communication network 206. The client computing devices 102a-102n can be similar to those described in relation with FIGS. 1A and 1B, and can be referred to herein, either individually or in combination, as client computing device(s) 102 or user computing device(s) 102. The databases 204a-204m can be referred to herein either individually or in combination as database(s) 204.

The client computing devices 102, the access management system 202 and the access management system 202, the databases 204 can be communicatively coupled via the communications network 206. The communication network 206 can include a cellular network, a landline network, an optical network, a metropolitan area network (MAN), a wide area network (WAN), the Internet, a private network, a public network or a combination thereof, among others. The communication network 206 can be similar to the network 104 of FIG. 1A. The communication network 206 can be distributed over a plurality of geolocations, metropolitan areas or countries.

The user computing devices 102 and the databases 204 can be associated with a computer environment 208, such as an enterprise computer network, a cloud network or system, a banking computer system, a power grid system, a medical device network, a social network, a communications network (e.g., wireless communications network), a media streaming system or network, a security monitoring system or a combination thereof, among others. In some implementations, the databases 204 can be located in a cloud, such as the cloud 108 of FIG. 1B. The databases 204 can store data associated with the computer environment 208. The data can be accessible to users of the computer environment 208. The users can include employees and/or contractors associated with the computer environment 208. Different users can be assigned different access permissions with respect to which data they can or cannot access. Each user computing device 102 can access data of the computer environment 208 from a remote location via the communication network 206 or from within the computer environment 208. The computer environment 208 can include a plurality of computing and/or network devices, such as computer servers, desktops, laptops, handheld devices, network switches, routers, firewalls or combination thereof, among others.

The access management system 202 can include one or more computing devices, such as the computing device 100 of FIGS. 1C and 1D. The access management system 202 can include a workspace generator component 210, a database constructor component 212 and a session handler component 214. Each of these components can be implemented as software, hardware or a combination thereof. As discussed in further detail below, the access management system 202 can manage users' access to data associated with the computer environment 208 or data stored by the database(s) 204. The access management system 202 can provide and/or communicate with a client application 216 installed and executing on the user computing devices 102.

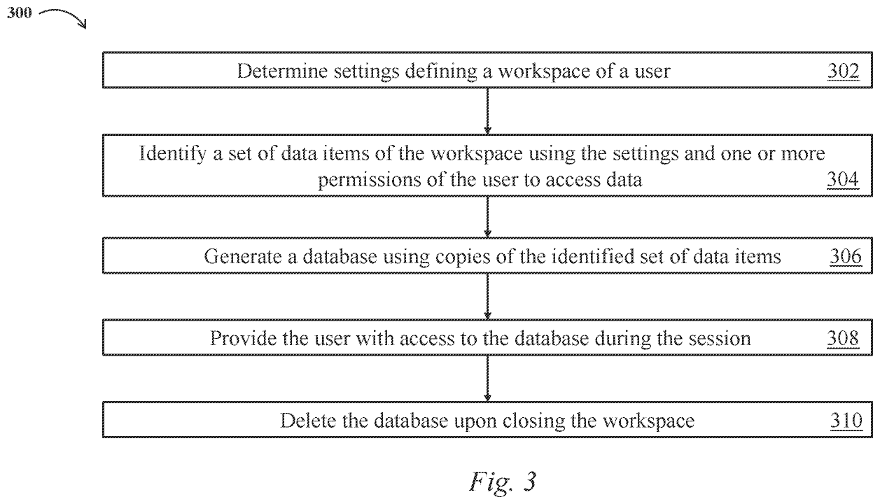

Referring now to FIG. 3, a flowchart illustrating a data access management method 300 is shown, according to example embodiments. In brief overview, the method 300 can include determining settings defining a workspace of a user (STEP 302), and identifying a set of data items of the workspace using the settings and one or more permissions of the user to access data (STEP 304). The method 300 can include generating a database of the workspace using copies of the set of data items (STEP 306), and providing the user access to the database (STEP 308). The method 300 can include deleting the database upon detecting closing of the workspace (STEP 310).

The method 300 can be implemented or executed by the access management system 202 or one or more processors thereof to limit, restrict or manage user access to data stored by the databases 204 and/or associated with the computer environment 208. In some implementations, the method 300 can be implemented through computer executable instructions stored on a computer-readable medium. The computer executable instructions when executed by one or more processors can cause the one or more processors to perform steps of the method 300.

Referring to FIGS. 2 and 3, the method 300 can include the access management system 202 or the workspace generator 210 determining settings defining a workspace of a user (STEP 302). The workspace generator 210 can determine the settings defining the workspace of the user responsive to a request from the user to establish a session with the workspace or responsive to a request to create the workspace. Creating the workspace can include the access management system 202 generating the settings defining the workspace. In other words, to create a new workspace, the workspace generator 210 can generate settings or parameters that define the data that belongs to, or that is associated with, the workspace. The settings defining the workspace can be viewed as a “recipe” that can be used to identify, retrieve or generate copies of data items that belong to, or that are associated with, the workspace.

In some implementations, the workspace generator 210 or the client application 216 can provide a user interface for creating a new workspace. The user of a computing device 102 may initiate creating or generating a new workspace, e.g., via the application 216. For example, upon the user logging in, the computing device 102 or the application 216 may display a message asking what the user wants to work one and/or provide options to open an existing workspace or create a new workspace. Upon the user initiating or triggering creation of a new workspace, the computing device 102 or the application 216 may provide or display a user interface (UI) for receiving input data regarding the new workspace.

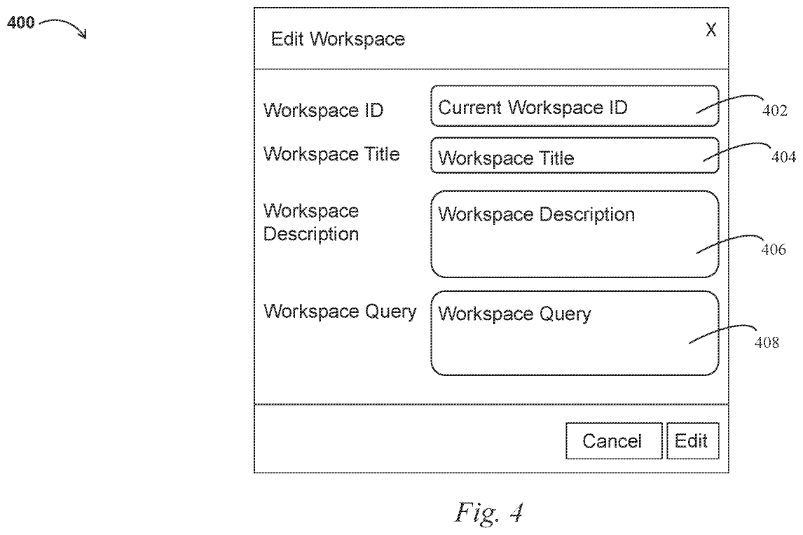

Referring to FIG. 4, an example UI 400 for receiving input data regarding a workspace is shown, according to example embodiments. The UI 400 can include a field 402 for entering a workspace identifier (ID), a field 404 for entering workspace title, a field 406 for entering a description of the workspace, and a workspace query field 408 for entering information indicative of the scope of the workspace or of the data associated with or belonging to the workspace. The scope of the workspace, or of the data associated with the workspace, can be defined via one or more criteria entered by the user in the workspace query filed. The one or more criteria can include, for example, a project name, a customer name, a customer ID, one or more identifiers or names of one or more assets of the computer environment 208, a category of assets of the computer environment 208, a geolocation, a time interval or a combination thereof, among others.

The computing device 102 or the application 216 can forward data entered by the user via the UI 400 to the access management system 202. The workspace generator 210 can receive the data entered via the UI 400, including the criteria defining the scope of the workspace, and generate the settings using the received data. The settings defining the workspace can include a workspace query that defines the scope or the extent of the data of the workspace. In some implementations, the workspace generator 210 can generate the workspace query using one or more criteria or terms entered by the user in the workspace query field of the UI 400. For example, a project name or project ID can be used as a search term to find all data items that are associated with the corresponding project. Also, the workspace generator 210 can use a customer name or customer ID as a search term to identify all data items associated with the corresponding customer. The user may enter one or more search terms in the workspace query field 408 of the UI 400, and the workspace generator 210 can generate a search query using the search terms entered by the user. In some implementations, the user can enter a search query (e.g., according a predefined format) including one or more search terms.

Besides the search query (or workspace query), the settings defining the workspace can include the workspace name, the workspace ID, the workspace description or a combination thereof, among others. The settings do not include the data of the workspace, but just define the data or the data items that belong to the workspace. As such, the access management system 202 can maintain only the settings defining the workspace and generate copies of the data that belongs to the workspace for use by the user only when needed.

In some implementations, the user when logging in can select to open an existing workspace, e.g., by entering the workspace name or the workspace ID. The access management system 202 can determine (e.g., retrieve from memory) the settings defining the workspace based on the workspace name or the workspace ID. As used herein, a request from the user to establish a session with the workspace can be a request to create a new workspace or a request to open an existing workspace. The session can be viewed as the time duration during which the workspace is kept open by the user. The session ends when the workspace is closed.

Referring back to FIGS. 2 and 3, the method 300 can include the access management system 202 identifying a set of data items of the workspace using the settings and one or more permissions of the user to access data (STEP 304). The database constructor 212 can use the workspace query to identify the data items that belong to the workspace. Specifically, the database constructor 212 can conduct a search (e.g., within the computer environment 208 or one or more databases 204) using the workspace query to identify the data items that belong to the workspace. As discussed above, the workspace query can include one or more search terms that identify the scope of the workspace and that are used by the database constructor 212 to identify the data items that belong to the workspace.

The method 300 can include the access management system 202 generating a database of the workspace using copies of the set of data items (STEP 306). The database of the workspace is also referred to herein as a session database or a temporary database. The database of the workspace is specific to the user in the sense that it is generated to be accessible by a single user, e.g., the user who established the session with the workspace only. The database of the workspace is maintained for temporary period, e.g., during the session when the workspace is accessed by the user.

The database constructor 212 can generate the session database using copies of the set of data items and one or more access control permissions of the user. The database constructor 212 can obtain the access control permissions of the user from access control policies and/or access control rules, e.g., maintained by a firewall or other security system of the computer environment 208. For instance, the database constructor 212 can identify a plurality of data items using the workspace query, and filter the plurality of identified data items using the access control permissions of the user. The filtering can result in a filtered set of data items. The database constructor 212 can generate copies of the filtered set of data items and store the copies in the session database. In some implementations, the database constructor 212 can store or maintain the session database locally (e.g., in the same geolocation as the user). In some implementations, the database constructor 212 can generate more than one user-specific session database of the workspace. For instance, some of the data items of the filtered set of data items may be subject to local regulations requiring the data to be maintained in the local geolocation or jurisdiction. In such case, the database constructor 212 can generate a first session database at a local geolocation of the user and a second session database at another jurisdiction to store copies of data items that cannot be transferred to the geolocation of the user. In some implementations, when generating the session database, the database constructor 212 can first identify all data items accessible to the user based on the control access permissions of the user, and then run a search using the workspace query on all data items accessible to the user.

The method 300 can include the access management system 202 providing the user access to the session database during the session established by the user with the workspace (STEP 308). For instance, the session handler 214 can provide a window or a UI for display on the computing device 102 of the user. The window or UI can include a listing of all data items (e.g., data files and/or folders), and can allow the user to open or access any of the data items. It is to be noted that the data items in the session database are copies of corresponding original data items. By providing access to the session database, the session handler 214 provides the user access to copies of data items associated with the workspace, but not the original data items.

The access to the session database can include allowing the user to display, edit or modify the data items, generate new data items and/or delete existing data items in the session database(s). The user can run a search within the session database(s) and/or generate statistical data (e.g., histograms, charts, tables, etc.) based on the data items in the session database(s). As the user takes actions with respect to the data items in the session database(s)e, the session handler 214 can detect such user actions in relation to the session database(s), and update the settings defining the workspace to add one or more indications of one or more user actions. For instance, the session handler 214 can add an indication of a user interface (UI) displaying data associated with the database(s) to the settings defining the workspace. The indication can include parameters defining, for example, a layout of the UI, data (or data items) displayed in the UI, colors of the UI. The UI indication or the corresponding parameters can be sufficient to regenerate the UI if the workspace is closed and open at a later time. For example, if the workspace is closed while the UI is displayed, when the user opens the workspace at a later time, the session handler 214 or the access management system 202 will automatically display the UI responsive to the user establishing a new session with the workspace.

The session handler 214 can add an indication of a modification to data in the database. The indication can include a set of instructions to cause the modification. The session handler 214 can add an indication of user settings (e.g., UI settings, audio settings, visual settings, etc.) for rendering data associated with the session database. The updating of the settings defining the workspace allows for maintaining additional parameters associated with (or indicative of) actions taken by the user in relation to the session database while accessing the workspace. When the user closes the workspace (or ends the session with the workspace) and reopens it at a later time, the session handler 214 or the access management system 202 can use the updated settings of the workspace to reproduce the same experience and/or the same data where the user left off when the first session was ended.

The access management system 202 or the session handler 214 can limit the maximum number of workspaces that can be accessed simultaneously by the user to a predefined number of workspaces. For example, the access management system 202 or the session handler 214 can limit the maximum number of workspaces that can be accessed simultaneously by the user (or any user) to a single workspace, two workspaces or other number. The access management system 202 or the session handler 214 can deny any requests or attempts by the user to access additional data (or additional workspaces) beyond the maximum number of workspaces that can be accessed simultaneously. In some implementations, the access management system 202 or the session handler 214 can detect or interpret some of such requests or attempts as suspicious behavior and may initiate some security measures, such as disconnecting the computing device 102 of the user or modifying the control access permissions of the user.

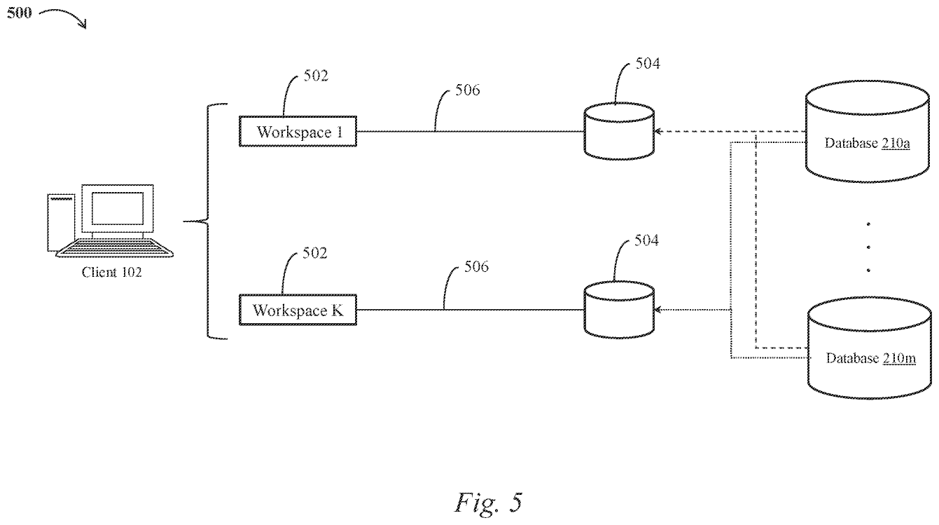

Referring now to FIG. 5, a diagram illustrating a scenario 500 where a user computing device 102 is accessing a plurality of workspaces is shown, according to example embodiments. The user or the corresponding computing device 102 can establish sessions with multiple workspaces 502. For each workspace 502, the session handler 214 can provide the user access to a user-specific session database 504 of that workspace 502. The session handler 214 can provide a separate virtual private network (VPN) tunnel 506 for each session database 504. In other words, for each of the session databases 504, the session handler 214 or the access management system 202 can establish a separate secure channel, such as a VPN tunnel 506, between the user computing device 102 and the session database 504. Establishing separate secure channels, e.g., VPN tunnels 506, adds another layer of security. For instance, a man-in-the middle would need to intercept all the secure channels or VPN tunnels 506 in order to access data from all the session databases 504 the user is accessing. Intercepting a single secure channel or VPN tunnel 506 gives the intruder access to data from a single session database 504.

Referring back to FIGS. 2 and 3, the method 300 can include the access management system 202 deleting the session database upon detecting closing of the workspace or ending of the session established with the workspace (STEP 310). The session handler 214 can detect closing of the workspace 502, and in response can automatically delete the corresponding session database 504. In other words, the session database 504 exists only while the session established with the workspace 502 is on (or while the workspace is still open). As soon as (or immediately after) the session ends or the workspace 502 is closed, the session handler 214 deletes the corresponding session database 504. Any changes made to the data items during the session can go through a review process before they are committed in the corresponding original data files. In some implementations, the session handler 214 may not delete the corresponding session database 504 once the workspace 502 is closed or the session is ended.

According to embodiments described herein, when a user logs in, even though the user may have access to millions of data points, the access management system 202 will give the user access to only a subset of these data points through one or more workspaces 502. For example, if the user wants to work on a workspace associated with IT infrastructure for California, the system will create a temporary database including copies of only data items related to California IT infrastructure. The created session database can include, for example, a subset of few thousands of data points related to California IT infrastructure. Each time the user logs in, the user can request launching the California Infrastructure workspace, and the system will load the subset of data points into a session database tied to the workspace.

From a processing speed or processing efficiency perspective, the use of the session database makes processing of data associated with the workspace faster and more efficient. For instance, any search query, any calculation, any simulation and/or any processing of the data initiated by the user will be run on the subset of data points preselected based on the scope of the workspace, rather than a larger set of data points. From a security perspective, even if someone was able to hack into the user's account while the user is logged in and working on the workspace, they will only have access to the data in the session database, not the full data set of data to which the user has permission to access.

Creating the session workspace can include the backend (or data center) cloning or making copies of the subset of data points related to the scope of the workspace in a local geolocation. If someone, for example, gets access to the computing device of the user (e.g., stealing the device while it is unlocked) and tries to access the data accessible by the user, they can access only the session database data. The session database includes copies of data items associated with the workspace but not the original data items. As such, the non-authorized user would only get access to copies of the data items but not the original data items.

### C. Session-Based Collaboration

Embodiments described herein relate to systems and methods for session-based collaboration. A first user can create a workspace as discussed above in Section B, and share the workspace or a user interface related to the workspace with a second user. In sharing the workspace, the computing device of the first user does not transmit any workspace data to the computing device of the second user. As such, shared data is not compromised. Specifically, if someone intercepts communications between the computing device of the first user and the computing device of the second user, the intercepted communication will not reveal anything meaningful about the data shared between the two users that can be used to determine or reconstruct data of the workspace.

The first user can initiate a sharing or collaboration session to share workspace data or a UI depicting workspace data with the second user. During the sharing or collaboration session, both users can see the same workspace content subject to the control access permissions for each user. In other words, the second user (e.g., the recipient) may view more, less or the same content as the first user depending on the control access permissions of both users. For instance, if the second user has permission to access more data related to the workspace than the first user, the second user may end up viewing more content than the first user during the sharing or collaboration session. However, if the second user has permission to access less data related to the workspace than the first user, the second user may end up viewing less content than the first user during the sharing or collaboration session.

A sharing or collaboration system can limit the data viewed by each user based on the control access permissions for that user. For example, when the first user is viewing or accessing content associated with a given context, such as one or more folders, one or more categories, one or more classifications and/or one or more customers, the sharing or collaboration system can apply the access control permissions of the first user to the content associated with the context to determine what content items can be viewed by the first user. Also, when the first user initiates a sharing or collaboration session with the second user, the sharing or collaboration system can apply the access control permissions of the second user to the content associated with the context to determine what content items can be viewed by the second user. By taking into account the control access permissions of each user in the backend to determine the content viewed by each user during the sharing or collaboration session, no content will be viewed by a user who does not have the access control permission(s) to access it. This approach adds another layer of data security during sharing or collaboration sessions.

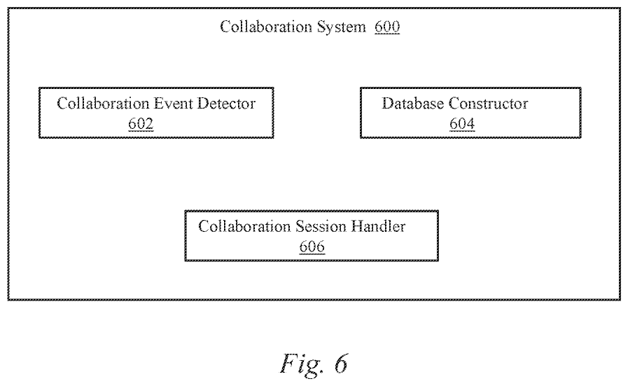

Referring now to FIG. 6, a block diagram of a collaboration system 600 is shown, according to example embodiments. The collaboration system 600 can include one or more computing devices, such as the computing device 100 of FIGS. 1C and 1D. For instance, the collaboration system 600 can include one or more computer servers, on or more desktops, on or more laptops or a combination thereof, among other computing devices. The computing device 100 can include session-based collaboration (SBC) software, e.g., instead of or in addition to the session-based access management software 120. The collaboration system 600 can include a collaboration event detector 602, a database constructor 604 and a collaboration session handler 606. Each of these components can be implemented as software, hardware or a combination thereof. For instance, each of the components 602, 604 and 606 can be implemented as computer executable instructions, which when executed by one or more processors 121 can cause the one or more processors 121 to perform the methods or method steps described in further detail below.

The collaboration system 600 can manage collaboration sessions or sharing of workspace data (e.g., a UI associated with a workspace) between different users or corresponding computing devices. Specifically, the collaboration system 600 can manage and control the data accessed by the sharer and the recipient(s).

The collaboration event detector 602 can detect sharing or collaboration events initiated by users. In particular, the collaboration event detector 602 can detect initiation by a sharer of a sharing or collaboration session between the sharer and a recipient (or one or more recipients). The recipient can receive a workspace identifier, a session identifier and/or a link upon the sharer initiating a sharing or collaboration session. The recipient can activate (e.g., by clicking) the received workspace identifier, session identifier and/or link, and the collaboration event detector 602 can detect the activation. For example, the link can be associated with an Internet Protocol (IP) address of a computing device of the collaboration system 600. Upon the recipient (or a computing device thereof) activating the link, a request can be made to the computing device of the collaboration system 600. The collaboration system 600 can detect the initiation of the sharing or collaboration session upon detecting or receiving the request.

The database constructor 604 can be similar to database constructor 212. The database constructor 604 can generate a session database for the recipient responsive to detection of the initiation of the sharing or collaboration session. The session database can be specific to the recipient and can be referred to as recipient-specific database. Specifically, the database constructor 604 can generate the session database based on settings defining a workspace of the sharer and access control permissions of the recipient. The session database specific to the recipient can define or include copies of data items of the workspace that are accessible by the recipient. The database constructor 604 can determine the settings defining the workspace based on the workspace ID, the session ID and/or the link, and can determine access control permissions of the recipient from access control policies and/or access control rules, e.g., maintained by a firewall or other security system.

In some implementations, the database constructor 604 can identify all the data items accessible to recipient using the access control permissions of the recipient, and then run the workspace query on all the data items accessible to recipient to identify a set of data items that belong to the workspace and that are accessible to the recipient. The database constructor 604 can make copies of the set of data items that belong to the workspace and that are accessible to the recipient, and generate the session database using the copies of the set of data items. The database constructor 604 can store the session database at a geolocation of the recipient. The session database generated by the database constructor 604 is to be accessed by the recipient only. The database constructor 604 can generate another session database for the sharer, for example, upon the sharer opening the workspace as discussed above in section B. The session databases of the sharer and the recipient can be separate databases where one of them can be accessible only by the sharer and the other can be accessible by only the recipient. While both session databases are generated based on the same workspace query, different access control permissions are considered in generating each one of them.

The collaboration session handler 606 can provide the recipient access to the recipient-specific session database. For instance, the collaboration session handler 606 can provide a window or a UI for display on the computing device 102 of the recipient. The window or UI can include a listing of all data items (e.g., data files and/or folders), and can allow the user to open or access any of the data items. By providing access to the session database, the collaboration session handler 606 can provide the recipient access to copies of data items associated with the workspace, but not the original data items. The collaboration session handler 606 can identify an indication of a UI associated with the workspace, and cause the UI to be displayed on the computing device 102 of the recipient using data from the session database specific to the recipient.

The UI can correspond to another UI displayed by the sharer. For instance, the sharer can save a template of the other UI (displayed by sharer's computing device) and share the template with the recipient. Saving the template can include saving an indication of the other UI in the settings defining the workspace. The UI displayed on the recipient's computing device and the other UI displayed on the sharer's computing device can have the same layout. Also, the content displayed in both UIs can be similar subject to the access control permissions of the sharer and the access control permissions of the recipient. In particular, the UI displayed on the recipient's computing device will show the same content (of the workspace) as that shown on the second UI (displayed on the sharer's computing device) except data items for which the recipient does not have permission(s) to access. Also, the second UI displayed on the sharer's computing device will show the same content (of the workspace) as that shown on the UI displayed on the recipient's computing device except data items for which the sharer does not have permission(s) to access. The template can be viewed as UI setting parameters that can be used by the collaboration system to generate corresponding UIs on various computing devices subject to differences between the access control permissions of the sharer and access control permissions of the recipient(s).

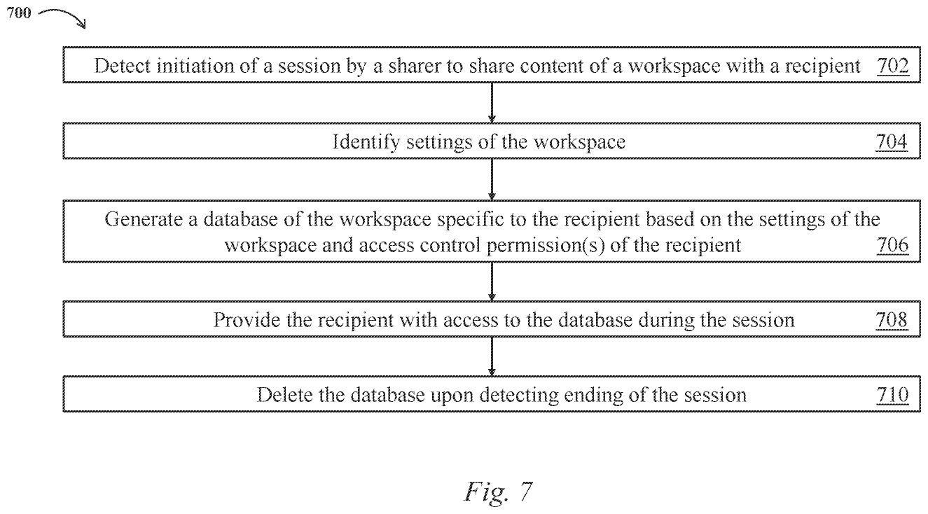

Referring now to FIG. 7, a flowchart illustrating a method 700 for session-based collaboration is shown, according to example embodiments. In brief overview, the method 700 can include detecting initiation of a session by a sharer to share content of a workspace with a recipient (STEP 702). The method 700 can include identifying settings of the workspace (STEP 704), and generating a session database of the workspace specific to the recipient based on the settings of the workspace and access control permissions of the recipient (STEP 706). The method 700 can include providing the recipient with access to the database during the session (STEP 708), and deleting the database upon detecting ending of the session (STEP 710).

The method 700 can include the collaboration system 600 or the collaboration event detector 602 detecting initiation of a session by a sharer to share content of a workspace with a recipient (STEP 702). As discussed in section B above, a first user (the sharer) can create and/or open a workspace. Upon opening the workspace by the first user, the access management system 202 or the collaboration system 600 can generate a database specific to the first user using settings defining the workspace and access control permissions of the first user. The database specific to the first user can include copies of data items that belong to the workspace and that are accessible to the first user. Users, e.g., employees in an organization, can have different access control permissions based on, for example, their positions in the organizations, projects they are working on and/or importance or sensitivity of various data items, among others.

The first user can cause display of one or more content items of the workspace on a first UI. The first user may then decide to initiate a session (e.g., a sharing or collaboration session) to share content of the workspace with a second user (the recipient). The first user can save a template of the first UI. For instance, the first UI can include or provide an icon (e.g., a “SAVE” icon) for saving a template of the first UI. Saving the template can include saving information indicative of the layout of the first UI, data items of the workspace displayed in the first UI, the workspace ID, a generated session ID or a combination thereof, among others. In other words, the template can include information or UI setting parameters sufficient together with data associated with the workspace to reproduce the first UI or corresponding UIs subject to access control permissions of other users. The collaboration system 600 can save the template within the workspace, e.g., with the settings defining the workspace. The collaboration system can generate a link (e.g., a hyperlink) of the template. In some implementations, the link can include the workspace ID and/or the session ID embedded therein.

In some implementations, the first UI may include or provide an icon (e.g., a “SHARE” icon or a “COLLABORATE” icon, among others) or other graphical control element to initiate the sharing or collaboration session. The first user can activate the icon, and in response, the collaboration system 600 or the collaboration event detector 602 can cause the link of the template to be sent to the second user (e.g., a second user's account) or the computing device of the second user. The UI can provide a data field, a drop-down list or other graphical control element for the first user to enter or select the name (or other identifier) of the second user. Detecting the initiation of the session can include the collaboration system 600 or the collaboration event detector 602 detecting the activation of the icon or other graphical control element to initiate the sharing or collaboration session by the first user and/or detecting the transfer or transmission of the link to the second user or the second user's computing device. For instance, the transfer or transmission of the link to the second user or the second user's computing device can be performed by the collaboration system 600 or the collaboration event detector 602 responsive to the activation the activation of the icon or other graphical control element to initiate the sharing or collaboration session.

The method 700 can include the collaboration system 600 or the database constructor 604 identifying settings of the workspace (STEP 704), and generating a session database of the workspace specific to the recipient based on the settings of the workspace and access control permissions of the recipient (STEP 706). The database constructor 604 can identify the workspace and/or settings of the workspace upon the second user activating the link of the template. For instance, the link can point to a server of the collaboration system 600, and the database constructor 604 can extract the workspace ID from the activated link. In some implementations, the database constructor 604 can extract the session ID from the activated link. The collaboration system 600 can maintain a data structure mapping or associating the session ID to the workspace ID. The database constructor 604 can determine the workspace ID based on the session ID and the data structure mapping or associating the session ID to the workspace ID.

The workspace constructor 604 can use the workspace ID to access the settings defining the workspace. The workspace constructor 604 can generate the session database specific to the second user using the settings defining the workspace and the control access permissions of the second user.

The database constructor 604 can use the settings defining the workspace or the workspace query therein to identify the data items that belong to the workspace. For instance, the database constructor 604 can perform a search (e.g., within the computer environment 208) using the workspace query to identify the data items that belong to the workspace. The workspace query can include one or more keywords that identify the scope of the workspace. The database constructor 604 can generate the session database specific to the second user using copies of the set of data items and one or more access control permissions of the second user. The access control permissions of the second user can be defined in access control policies and/or access control rules, e.g., maintained by a firewall or other security system. In some implementations, the database constructor 604 can identify a plurality of data items using the workspace query, and filter the plurality of identified data items using the access control permissions of the second user. The database constructor 604 can generate copies of the filtered set of data items and store the copies in the session database specific to the second user.

The database constructor 604 can store or maintain the session database locally (e.g., in the same geolocation as the second user). In some implementations, the database constructor 604 can generate more than one session databases specific to the second user. For instance, some of the data items of the filtered set of data items may be subject to local regulations requiring the data to be maintained in the local jurisdiction. In such case, the database constructor 604 can generate a first session database at a local geolocation of the second user and a second session database at another jurisdiction to store copies of data items that cannot be transferred to the geolocation of the second user. In some implementations, when generating the session database, the database constructor 604 can first identify all data items accessible to the second user based on the control access permissions of the second user, and then run a search using the workspace query on all data items accessible to the second user.

The database constructor 604 can maintain the session database specific to the second user for temporary period, e.g., during the collaboration or sharing session between the first user and the second user. The session database specific to the second user can be accessible only to the second user. The collaboration system 600 can use the session database specific to the second user to cause display of a second UI on the computing device of the second user.

The method 700 can include the collaboration system 600 or the collaboration session handler 606 providing the second user with access to the database during the session (STEP 708). The collaboration session handler 606 can generate the second UI, for display on the computing device of the second user responsive to activation of the link by the computing device of the second user, using the template of the first UI (e.g., referenced by the link) and data items in the session database specific to the second user. The collaboration session handler 606 can generate the second UI for display on the to mirror the first UI subject to the differences between the access control permissions of the first user and the access control permissions of the second user.

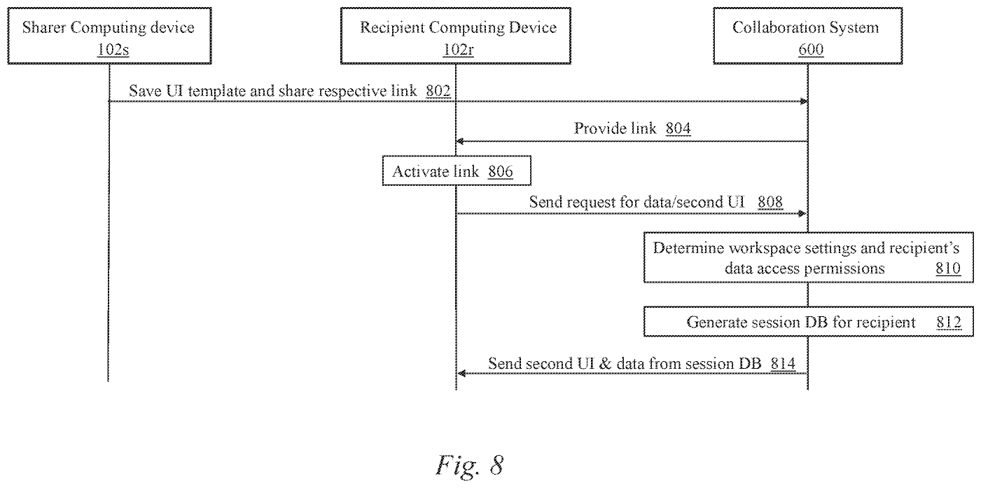

Referring now to FIG. 8, a signaling flowchart 800 illustrating communications associated with a collaboration session between computing devices 102s and 102r of two users and the collaboration system 600 is shown, according to example embodiments. The communications relate to initiating and managing the collaboration session. Upon opening a workspace and/or displaying content associated with the workspace in a first UI, the sharer's computing device 102s can cause the collaboration system 600 to save a template of the first UI (STEP 802). As discussed above, the first UI can include or provide an icon (e.g., a “SAVE” icon) for saving a template of the first UI. Saving the template can include saving information indicative of the layout of the first UI, data items of the workspace displayed in the first UI, the workspace ID, a generated session ID or a combination thereof, among others. The template can include information or UI setting parameters used to reproduce the first UI or corresponding UIs subject to access control permissions of other users. The collaboration system 600 can save the template within the workspace, e.g., with the settings defining the workspace.

The collaboration system 600 can generate a link (e.g., a hyperlink) of the template, and send the link to the recipient's computing device 102r (STEP 804). The collaboration system 600 can send the link to the computing device 102r, responsive to the computing device 102s initiating a sharing or collaboration session. In some implementations, the link can include the workspace ID and/or the session ID embedded therein. In some implementations, the collaboration system 600 may send the link back to the computing device 102s, and the computing device 102s can forward the link to the computing device 102r.

The computing device 102r can activate the received link (STEP 806) to cause a request for data (or for a UI) to be sent to the collaboration system 600 (STEP 808). The sharer can, for example, click the received link or activate an icon associated with the link. In response, the computing device 102r can send a request for a second UI and/or data associated with the second UI. The request can include the link and an identifier of the recipient or the computing device 102r. In some implementations, the computing device 102r can append the link with the identifier of the recipient or the computing device 102r.

The collaboration system 600 can use information, e.g., session ID, workspace ID and/or ID of the recipient or the computing device 102r, to determine or identify the workspace and determine data access permissions for the recipient (STEP 810). The collaboration system 600 can use session ID or the workspace ID to identify the workspace and use the ID of the recipient or the computing device 102r to identify the recipient. The collaboration system 600 can use a query of the workspace to identify or determine (e.g., via a search within computer environment 208) data items associated with the workspace. The collaboration system 600 can obtain, e.g., from an access policy database, data access permissions of the recipient using the ID of the recipient or the computing device 102r to identify the recipient.

The collaboration system 600 can generate a session database specific to the recipient (STEP 812). The generation or creation of the session database can be similar to STEP 306 in FIG. 3, except that the session is specific to the recipient. The collaboration system 600 can filter the data items of the workspace based on data permissions (or data permission rules) of the recipient. The collaboration system 600 can generate the session data base of the recipient to include copies (e.g., not original data items) of the filtered data items. The session database of the recipient can include copies of data items accessible to the recipient during the collaboration or sharing session.

The collaboration system 600 can send a second UI and/or data from the session database of the recipient to the computing device 102r (STEP 814). The collaboration system 600 can use setting parameters in the template to generate a second UI for display on the computing device 102r. The second UI can display only workspace content stored or maintained in the session database of the recipient.

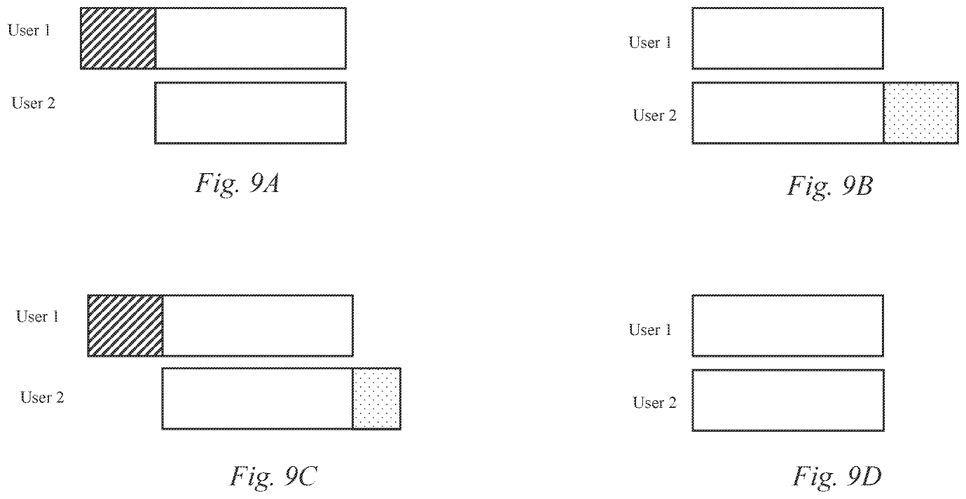

Referring now to FIGS. 9A-9D, diagrams illustrating various scenarios for data displayed on the first and second UIs are shown, according to example embodiments. The rectangles associated with “User 1” represent the data displayed in the first UI to the first user (e.g., sharer or initiator of collaboration/sharing session) while the rectangles associated with “User 2” represent the data displayed in the second UI to the second user (e.g., recipient). The white areas in the various scenarios represent data of the workspace accessible to both users and that would be displayed in both UIs if accessed by any of the users. The hashed areas represent data items of the workspace that are accessible to the first user but not to the second user. Such data items if displayed by the first user in the first UI would not be displayed in the second UI to the second user. The dotted areas represent data items of the workspace that are accessible to the second user but not to the first user. Such data items if displayed by the second user in the second UI would not be displayed in the first UI to the first user.

The scenario in FIG. 9A represents a case where the first user views more than the second user. FIG. 9B depicts a scenario where the second user views more than the second user. FIG. 9C depicts a scenario where the first UI shows common data items (white areas common to both) that are viewed by both users in both UIs and data items (hashed area) that are displayed only in the first UI but not in the second UI. The second UI shows the common data items (white areas common to both) that are viewed by both users in both UIs and data items (dotted area) that are displayed only in the second UI but not in the first UI. FIG. 9D depicts a scenario where both UIs show the same data items (white area) that are accessible to both users.

The collaboration session handler 606 can monitor activities by both users in both UIs, and update the content displayed in both or one of the UIs accordingly. For instance, any of the users can cause additional data items of the workspace to be displayed in the corresponding UI. In response the collaboration session handler 606 can update the content displayed in both UIs subject to the access control permissions of each of the users. For instance, if the second user requests display of an additional data item in the second UI, the collaboration session handler 606 can check if the second user has permission to access the additional data item. If the collaboration session handler 606 determines that the additional data item is accessible to the second user, the collaboration session handler 606 can cause the additional data item to be displayed in the second UI for the second user to view. The collaboration session handler 606 can also check if the additional data item is accessible to the first user, and if yes, the collaboration session handler 606 can cause the additional data item to be displayed in the first UI for the first user to view. The collaboration session handler 606 can perform a similar process if the user requested the display of the additional data item. During the sharing or collaboration session, the collaboration session handler 606 can cause both UIs to display the same workspace content subject to the differences between the access control permissions of each of the users. That is, both users can interact with content displayed in corresponding UIs, for example, to make modifications. The interactions or modifications can be instantly reflected or viewed in both UIs displayed on the computing devices of both users subject to the access control permissions of each of the users.

In some implementations, the collaboration session handler 606 can detect a modification to the second UI displayed on the computing device of the second user (or to the first UI displayed on the computing device of the first user), and UI setting parameters responsive to detecting the modification to the second UI. For instance, if the second user causes display of an additional data item of the workspace in the second UI, the collaboration session handler 606 can update the UI settings parameters to indicate that the additional data item is being shared between both users. The collaboration session handler 606 can cause the computing device of the first user to update the first UI displayed thereon responsive to updating the UI setting parameters subject to the access control permissions of the first user. The collaboration session handler 606 will update the UI settings parameters if the first user causes display of the additional data item of the workspace in the first UI, and will cause the computing device of the second user to update the second UI displayed thereon based on the updated UI setting parameters.

In some implementations, the collaboration session handler 606 can cause display of a third UI on the computing device of the second user and/or the computing device of the first user. The third UI can depict data items common to both the UIs (e.g., accessible to both users). As such, each of the users can view or have access to two UIs. The first user can view the first and third UIs, while the second user can view the second and the third UI.

In providing access to the session database, the collaboration session handler 606 can provide or a secure channel (e.g., VPN tunnel) between the computing device of the second user and the session database specific to the second user. In the case where the database constructor 604 generates multiple session databases specific to the second user, the collaboration session handler 606 can provide a separate secure (e.g., a separate VPN tunnel) channel for each database specific to the second user.

The method 700 may include the collaboration system 600 or the database constructor 604 deleting the database upon detecting ending of the session (STEP 710). If any of the users or the corresponding computing device ends the sharing or collaboration session, the collaboration system 600 or the database constructor 604 may delete the session database specific to the second user. The collaboration system 600 or the database constructor 604 may delete the workspace database specific to the first user upon the first user or the corresponding computing device ending the session or closing the workspace. The collaboration system 600 or the database constructor 604 may delete the session database specific to the second user responsive to any of the computing devices of the first user and/or the second user shutting down. In some implementations, the collaboration system 600 or the database constructor 604 may keep the session database specific to the first and/or second user upon any or both of the computing devices of the first user and/or the second user ending the collaboration session.

While the disclosure has been particularly shown and described with reference to specific embodiments, it should be understood by those skilled in the art that various changes in form and detail may be made therein without departing from the spirit and scope of the invention described in this disclosure.

While this disclosure contains many specific embodiment details, these should not be construed as limitations on the scope of any inventions or of what may be claimed, but rather as descriptions of features specific to particular embodiments of particular inventions. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

1. A system comprising:
one or more processors; and
a memory storing computer executable instructions, the computer executable instructions, when executed by the one or more processors, cause the one or more processors to:
detect initiation of a session by a first user to share content of a workspace with a second user;
identify, based at least on the initiation of the session, settings defining the workspace;
generate a database of the workspace specific to the second user using the settings and one or more access control permissions of the second user, the database including copies of data items of the workspace to which the second user has permission to access; and
provide the second user access to the database during the session.

2. The system of claim 1, wherein the one or more processors are further configured to delete the database upon detecting ending the session.

3. The system of claim 1, wherein the initiation of the session includes:
a computing device of the second user receiving a link of the workspace from a computing device of the first user; and
the computing device of the second user activating the link, in detecting the initiation of the session, the one or more processors are configured to detect activation of the link by the computing device of the second user.

4. The system of claim 3, wherein the link includes at least one of a workspace identifier or a session identifier.

5. The system of claim 1, wherein the settings defining the workspace include one or more user interface (UI) setting parameters, and the one or more processors are configured to cause display of a first UI on a computing device of the second user using the one or more UI setting parameters and the session database specific to the second user, the first UI displaying data associated with the session database specific to the second user.

6. The system of claim 5, wherein the first UI corresponds to a second UI displayed on a computing device of the first user, and wherein the one or more processors are configured to:
generate the one or more UI setting parameters to define at least one of a layout of the second UI or data associated with the workspace that is displayed by the second UI.

7. The system of claim 6, wherein data displayed by the first UI is similar to data displayed by the second UI except that the data displayed by the first UI is limited to data associated with the workspace that is accessible by the second user and data displayed by the second UI is limited to data associated with the workspace that is accessible by the first user.

8. The system of claim 6, wherein the one or more processors are further configured to:
detect a modification to the second UI displayed on the computing device of the first user; and
update the one or more UI setting parameters responsive to detecting the modification to the second UI, the computing device of the second user updating the first UI displayed thereon responsive to updating the one or more UI setting parameters.

9. The system of claim 6, wherein the one or more processors are further configured to cause display of a third UI on the computing device of the second user, the third UI depicting data common to both the first UI and the second UI.

10. The system of claim 1, wherein the settings defining the workspace include a query indicative of a scope of data associated with the workspace, and wherein in generating the database specific to the second user, the one or more processors are configured to:
identify a plurality of data items associated with the workspace using the query;
filter the plurality of data items using the one or more data access permissions of the second user to identify a filtered set of data items associated with the workspace and accessible by the second user; and
generate the session database to include copies of the filtered set of data items.

11. A method comprising:
detecting, by one or more processors, initiation of a session by a first user to share content of a workspace with a second user;
identifying, by the one or more processors and based at least on the initiation of the session, settings defining the workspace;
generating, by the one or more processors, a database of the workspace specific to the second user using the settings and one or more access control permissions of the second user, the database including copies of data items of the workspace to which the second user has permission to access; and
providing, by the one or more processors, the second user access to the database during the session.

12. The method of claim 11, further comprising:
deleting, by the one or more processors, the database upon detecting ending the session.

13. The method of claim 11, wherein the initiation of the session includes:
a computing device of the second user receiving a link from a computing device of the first user; and
the computing device of the second user activating the link, detecting the initiation of the session includes detecting activation of the link by the computing device of the second user.

14. The method of claim 11, wherein the settings defining the workspace include one or more user interface (UI) setting parameters, the method further comprising causing display of a first UI on a computing device of the second user using the one or more UI setting parameters and the session database specific to the second user, the first UI displaying data associated with the database specific to the second user.

15. The method of claim 14, wherein the first UI corresponds to a second UI displayed on a computing device of the first user, the method further comprising:
generating, by the one or more processors, the one or more UI setting parameters to define at least one of a layout of the second UI or data associated with the workspace that is displayed by the second UI.

16. The method of claim 15, wherein data displayed by the first UI is similar to data displayed by the second UI except that data displayed by the first UI is limited to data associated with the workspace that is accessible by the second user and data displayed by the second UI is limited to data associated with the workspace that is accessible by the first user.

17. The method of claim 15, further comprising:
detecting, by the one or more processors, a modification to the second UI displayed on the computing device of the first user; and
updating, by the one or more processors, the one or more UI setting parameters responsive to detecting the modification to the second UI, the computing device of the second user updating the first UI displayed thereon responsive to updating the one or more UI setting parameters.

18. The method of claim 15, further comprising causing display of a third UI on the computing device of the second user, the third UI depicting data common to both the first UI and the second UI.

19. The method of claim 11, wherein the settings defining the workspace include a query indicative of a scope of data associated with the workspace, and wherein generating the database specific to the session of the second user includes:
identifying, by the one or more processors, a plurality of data items associated with the workspace using the query;
filtering, by the one or more processors, the plurality of data items using the one or more data access permissions of the second user to identify a filtered set of data items associated with the workspace and accessible by the second user; and
generating, by the one or more processors, the database to include copies of the filtered set of data items.

20. A non-transitory computer-readable medium storing computer executable instructions, the computer executable instructions when executed by one or more processors cause the one or more processors to:
detect initiation of a session by a first user to share content of a workspace with a second user;
identify, based at least on the initiation of the session, settings defining the workspace;
generate a database of the workspace specific to the second user using the settings and one or more access control permissions of the second user, the database including copies of data items of the workspace to which the second user has permission to access;
provide the second user access to the database during the session.
